(19) United States
(12) Patent Application Publication
(10) Pub. No.: US 2014/0273605 A1
(43) Pub. Date: Sep. 18, 2014

(54) CONNECTOR

(71) Applicant: TELEBOX INDUSTRIES CORP., New Taipei City (TW)

(72) Inventors: Ray CHANG, New Taipei City (TW); Fu-Wen WU, Keelung City (TW); Chien-Ming TU, Keelung City (TW); Chang-Huang LEE, New Taipei City (TW)

(73) Assignee: TELEBOX INDUSTRIES CORP., New Taipei City (TW)

(21) Appl. No.: 13/797,092

(22) Filed: Mar. 12, 2013

(51) Int. Cl. H01R 4/24

(52) U.S. Cl. CPC H01R 4/2491
USPC 439/391

(57) ABSTRACT

A connector includes a casing, a circuit board, a joint and an adapter. The casing has an accommodating space. The circuit board, located in the accommodating space, has multiple conductive contacts. The joint, assembled on the casing, is electrically connected to the circuit board. The adapter module, detachably assembled in the accommodating space, includes a first body, a second body and multiple piercing terminals. The first body has multiple insertion slots. The second body is combined with the first body. The multiple piercing terminals, located on the second body, correspond to the insertion slots and are electrically connected to the multiple conductive contacts.

### TECHNICAL FIELD

The disclosure relates to a connector, and more particularly to a connector having a plurality of piercing terminals.

### BACKGROUND

A conventional pierce-type connector is used for connecting a transmission cable, and the pierce-type connector generally comprises a main body, a joint, a plurality of piercing terminals and a patching jack. The joint, assembled on one end of the main body, may be a male joint or a female joint, depending on the type of the connector. These piercing terminals are located on the main body, and electrically connected to the joint. Generally the patching jack can be pivoted on the main body, where branch lines of the transmission cable are inserted.

When intending to connect the connector to the transmission cable, a user pivots the patching jack to an open position relative to the main body. Next, the user inserts the branch lines into the patching jack of the connector, and then pivots the patching jack from the open position to a closed position relative to the main body, so that the transmission cable and the connector are fixed together. At the same time, the piercing terminals of the main body may pierce through an insulation sheath of the branch lines (ribbons) of the transmission cable correspondingly, thus the pierce terminals may electrically contact conductive cores of the branch lines. In this way, the transmission cable may be electrically connected to the joint of the connector, so as to complete jointing as well as assembling of the connector and the transmission cable.

However, the joint type of above-mentioned connector is already fixed (set); if the transmission cable is required to be connected to a connector having a female joint, instead of a male joint, the branch lines of the transmission cable must be detached from the piercing terminals. Actually, the piercing terminals electrically contact the branch lines of the transmission cable in a braking mode, thus the connection quality between the transmission cable and the connector is declined, and even damage of the connector may occur after several times of assembly and disassembly of them.

### SUMMARY

According to an embodiment of the disclosure a connector comprises a casing, a circuit board, a joint and an adapter. The casing has an accommodating space. The circuit board, located in the accommodating space, has a plurality of conductive contacts. The joint, assembled on the casing, is electrically connected to the circuit board. The adapter module, detachably assembled in the accommodating space, comprises a first body, a second body and a plurality of piercing terminals. The first body has a plurality of insertion slots. The second body is combined with the first body. The plurality of piercing terminals, located on the second body, correspond to the insertion slots and are electrically connected to the plurality of conductive contacts.

### BRIEF DESCRIPTION OF THE DRAWINGS

The disclosure will become more fully understood from the detailed description given herein below for illustration only, thus does not limit the disclosure, wherein:

FIG. 1 is a structural perspective view of a connector according to one embodiment of the disclosure;

FIGS. 2A and 2B are structural exploded views of the connector according to FIG. 1;

FIG. 3A is a front view of piercing terminals in FIG. 2A;

FIG. 3B is a side view of the piercing terminals in FIG. 2A;

FIG. 4A is a front view of piercing terminals according to another embodiment of the disclosure;

FIG. 4B is a side view of the piercing terminals according to another embodiment of the disclosure;

FIGS. 5A to 5E are an assembly schematic views of the connector and a transmission cable in FIG. 2A;

FIG. 6 is a structural perspective view of the connector according to another embodiment of the disclosure;

FIG. 7 is a structural exploded view of the connector in FIG. 6; and

FIGS. 8A to 8E are assembly schematic views of the connector and transmission cable in FIG. 6.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Please refer to FIGS. 1, 2A and 2B. FIG. 1 is a structural perspective view of a connector according to one embodiment of the disclosure, and FIGS. 2A and 2B are structural exploded views of the connector in FIG. 1.

The connector 10 of this embodiment is a connector having a male joint, for example, the connector 10 is a plug connector, but not limited to this disclosure. In other embodiments, a connector 10 is a connector with female joint.

The connector 10 comprises a casing 11, a carrier 12, a circuit board 13, a male joint 14 and an adapter module 15.

The casing 11 has an accommodating space 112. Furthermore, in this embodiment, the inner wall of the casing 11, located at two opposite sides of the accommodating space 112, have two guide channels 111. It should be noted that the number of the guide channels 111 is two, but not limited to this, and those familiar with the art may adjust the number of guide channels 111 according to the actual demands. In addition, the casing 11 also has a pair of clamping grooves 115. One end of the casing 11 is also provided has a retainer ring 114 adjacent to the clamping grooves 115. The material of the casing 11 is metal, but not limited to the disclosure.

The carrier 12 is assembled in the accommodating space 112, and the material of the carrier 12 is insulating materials, but not limited to the disclosure.

The circuit board 13 is assembled on the carrier 12 and is positioned in the accommodating space 112. The circuit board 13 includes a plurality of conductive contacts 131. The carrier 12 is used for electrically insulating the circuit board 13 and the casing 11. It should be noted that, in other embodiments, when the material of the casing is non-conductive, the connector 10 may not include a carrier 12, such that the circuit board 13 can be assembled directly in the accommodating space 112 of the casing 11 without any carrier 12.

The joint 14 is assembled on one end of the casing 11 and the end is away from the retainer ring 114. The joint 14 has a plurality of electrical contacts 141, are a plurality of side-by-side conductive metal sheets, but not limited to the disclosure. One end of the joint 14 is combined with the circuit board 13, such that the plurality of electrical contacts 141 of the joint 14 are electrically connected to the plurality of electrical contacts 131 of the circuit board 13. Furthermore, the plurality of electrical contacts 141 of the joint 14 are exposed outside the casing 11, that is, the joint 14 of this embodiment is a male joint.

The adapter module 15, detachably assembled in the accommodating space 112, comprises a first body 151, a second body 152 and a plurality of piercing terminals 153.

The first body 151 has a plurality of insertion slots 1511 arranged in two columns side by side, but the arrangement type of the plurality of insertion slots 1511 is not used for limiting this disclosure. The plurality of insertion slots 1511 are used for insertion of a plurality of branch lines of the transmission cable. Additionally, the first body 151 of this embodiment has a plurality of hooks 1512 and a pair of pivot shafts 1513.

The second body 152 has a plurality of holes 1524 and a pair of pivoting holes 1525. The holes 1524 correspond to the plurality of hooks 1512 of the first body 151. The pivot shafts 1513 are inserted into the pair of pivoting holes 1525, so that the first body 151 is pivoted to the second body 152 and thus is adapted for being opened or closed relative to the second body 152. Furthermore, the second body 152 has a plurality of guiding protruding parts 1523 corresponding to the guide channels 111 of the casing 11, thereby achieving a guiding and positioning effect when the adapter module 15 is assembled in the accommodating space 112. Moreover, the second body 152 also has an inner surface 1521 and an outer surface 1522 opposite to each other. The inner surface 1521 faces toward the plurality of insertion slots 1511 of the first body 151. Additionally, the materials of first body 151 and the second body 152 are both plastics.

The material of the plurality of piercing terminals 153 is metal, and the plurality of piercing terminals 153 are combined with the second body 152 by insert molding, but this combining manner is not used for limiting this disclosure. Each of the plurality of piercing terminals 153 has a piercing end 1531 and a connection end 1532 opposite to each other. The piercing end 1531 protrudes outward from the inner surface 1521 and faces toward one of the plurality of insertion slots 1511. The connection end 1532 protrudes outward from the outer surface 1522. The plurality of piercing ends 1531 of the plurality of piercing terminals 153 are used for piercing (namely, puncturing) an insulation sheath of a plurality of branch lines 21 located in the plurality of insertion slots 1511, so that the piercing terminals 153 contact the conductive cores of the plurality of branch lines 21, thus achieving an electrical connection between the plurality of piercing terminals 153 and the plurality of branch lines 21. The plurality of connection ends 1532 of the plurality of piercing terminals 153 are used for electrically contacting the conductive contacts 131 of the circuit board 13.

Moreover, in this embodiment, the connector 10 also comprises an outer lid 16. One end of the outer lid 16 is pivoted to the casing 11, while the other end of the outer lid 16 has a pair of clamping pieces 162 corresponding to the plurality of clamping grooves 115 of the casing 11. When the adapter module 15 is positioned in the accommodating space 112, the outer lid 16 may be pivoted relative to the casing 11 such that the clamping pieces 162 are clamped in the clamping grooves 115, and thus the outer lid 16 is located at a closed position, so as to cover and avoid the adapter module 15 from being exposed. The material of the outer lid 16 is metal, but not limited to the disclosure.

Furthermore, in this embodiment, the adapter module 15 has a cross-shaped spacer sheet 154, and the material of the spacer sheet 154 is metal. The spacer sheet 154 is combined with the first body 151 by insert molding, but this combining manner is not used for limiting this disclosure. When a plurality of branch lines 21 of a transmission cable 20 are combined with the adapter module 15, the spacer sheet 154 can separate the branch lines 21 into four quadrants (namely, quarters or parts). The spacer sheet 154 may absorb the noise from the plurality of branch lines 21, so as to avoid signal interferences occurred among the plurality of branch lines.

Moreover, the outer lid 16 can also be internally provided with an elastic sheet 161. When the outer lid 16 is pivoted to the closed position relative to the casing 11, the elastic sheet 161 contacts the spacer sheet 154 electrically. In this way, the spacer sheet 154 may absorb the noise before the noise is guided to the outer lid 16 by the elastic sheet 161.

In addition, in this embodiment, the connector 10 also comprises an engaging piece 17 assembled on one side of the casing, and the side is away from the outer lid 16. The engaging piece 17 is used for providing fastening between the connector 10 and another connector (not shown).

Then please refer to FIGS. 3A and 3B. FIG. 3A is a front view of the piercing terminals in FIG. 2A. FIG. 3B is a side view of the piercing terminals in FIG. 2A.

Typically, the piercing end 1531 of each piercing end 153 in this embodiment has three piercing components 1533 arranged in a staggered form. The three piercing components 1533 have sharp surfaces, so as to facilitate piercing the insulation sheath of the plurality of branch lines 21. Furthermore, the connection end 1532 of each piercing end 153 also has an elastic arm structure 1534 whose extension direction is substantially the same with the arrangement direction of the three piercing components 1533. Therefore, the configuration of elastic arm structures 1534 may improve the electrical contact effect between the plurality of connection ends 1532 of the plurality of piercing terminals and the plurality of conductive contacts 131 of the circuit board 13.

It should be noted that the number and arrangement pattern of the piercing components 1533 and the extension direction of the elastic arm structures 1534 are not used for limiting this disclosure, and those familiar with the art may adjust according to the actual demands. For example, as shown in FIGS. 4A and 4B, in other embodiments, the piercing end 1531′ of each piercing end 153′ also has two piercing components 1533′, and the two piercing components 1533′ are arranged side by side. Furthermore, the connection end 1532′ of each piercing end 153′ also has an elastic arm structure 1534′ whose extension direction is also substantially perpendicular to the arrangement direction of the two piercing components 1533′.

The following describes how the transmission cable 20 and the connector 10 are assembled. Next, please refer to FIG. 5A to FIG. 5E, with reference to FIG. 2B. FIGS. 5A to 5E are an assembly schematic views of the connector and the transmission cable in FIG. 2A.

Please refer to FIGS. 5A and 5B, firstly, the first body 151 is opened relative to the second body 152, then the branch lines 21 of the transmission cable 20 are inserted into the plurality of insertion slots 1511 of the first body 151.

Then, as shown in FIGS. 5C and 5D, the first body is moved to cover the second body 152, such that the hooks 1512 of the first body 151 are engaged in the plurality of holes 1524 of the second body 152. At this time, the plurality of piercing ends 1531 of the plurality of piercing terminals 153 may pierce the insulation sheath of the plurality of branch lines 21 so as to contact the plurality of conductive cores of the plurality of branch lines 21, thus achieving an electrical connection between the plurality of piercing terminals 153 and the plurality of branch lines 21.

Afterwards, as shown in FIG. 5E, the outer lid 16 is opened relative to the casing 11, thereby exposing the accommodating space 112 of the casing 11. The guiding protruding parts 1523 of the adapter module 15 are aligned to the plurality of guide channels 111, enabling the adapter module 15 to guide the guiding protruding parts 1523 to slide by means of the plurality of guide channels 111. In this way, the adapter module 15 is accurately placed at a predetermined location in the accommodating space 112, so that the connection ends 1532 of the piercing terminals 153 of the adapter module 15 may electrically contact the conductive contacts 131 of the accommodating space 112 accurately. Finally, the outer lid 16 is closed and the retainer ring 114 retains the transmission cable 20 to fix it, thus completing the assembly of the transmission cable 20 and the connector 10.

It should be noted that the connector 10 of the embodiment in FIG. 2A is a connector with male type joint, but not limited to the disclosure. The connector 10 in the following embodiment is a connector with female type joint, for example, the connector 10 is a keystone jack, but not limited to the disclosure.

Please refer to FIGS. 6 to 8E. FIG. 6 is a structural perspective view of the connector according to another embodiment of the disclosure, FIG. 7 is a structural exploded view of the connector in FIG. 6, and FIGS. 8A to 8E are assembly schematic views of the connector and the transmission cable in FIG. 6.

The connector 10a in this embodiment comprises a casing 11a, a carrier 12a and a circuit board 13a, a joint 14a and an adapter module 15a.

The casing 11a has an accommodating space 112a and a slot 113a communicating with the accommodating space 112a.

The carrier 12a is assembled in the accommodating space 112a. Additionally, the carrier 12a has two guide channels 111a, but the number of the guide channels 111a is not used for limiting this disclosure.

The circuit board 13a is assembled on the carrier 12a and is positioned in the accommodating space 112a. The circuit board 13a has a plurality of conductive contacts 131a.

The joint 14a has a plurality of electrical contacts 141a, which are conductive metal wires arranged side by side, but not limited to this disclosure. The joint 14a is combined with the circuit board 13a, such that the electrical contacts 141a of the joint 14a are electrically connected to the plurality of conductive contacts 131a of the circuit board 13a. Furthermore, the joint 14a is assembled in the slot 113a of the casing 11a, where the electrical contacts 141a are exposed, that is, the joint 14a of this embodiment is a female joint.

The adapter module 15a, detachably assembled in the accommodating space 112a, comprises a first body 151a, a second body 152a and a plurality of piercing terminals 153a.

The first body 151a has a plurality of insertion slots 1511a arranged in two columns, but the arrangement type of the insertion slots 1511a is not used for limiting this disclosure. Additionally, the first body 151a of this embodiment also has a plurality of hooks 1512a.

The second body 152a can have a plurality of holes 1524a. The plurality of holes 1524a are corresponding to the plurality of hooks 1512a of the first body 151a, such that the second body 152a is detachably combined with the first body 151a. Further, the second body 152a can also have a plurality of guiding protruding parts 1523a corresponding to the guide channels 121a of the carrier 12a, thereby achieving a guiding and positioning effect when the adapter module 15a is assembled in the accommodating space 112a.

These piercing terminals 153a are assembled on the second body 152a. Because the overall structure of the piercing terminals 153a and the connection relation between the plurality of piercing terminals 153a and the second body 152a are substantially the same with the embodiments of FIGS. 2A to 3B, therefore it is unnecessary to repeat any more herein.

Furthermore, the connector 10a further comprises a grounding piece 19a located in the slots 113a and adapted for providing a grounding effect.

In addition, the connector 10a further comprises a rear cover 18a fixed on one end of the carrier 12a and positioned on one end of the circuit board 13a away from the joint 14a.

When a transmission cable 20 needs to be assembled on a connector 10a, firstly, the transmission cable 20 and the adapter module 15a are assembled, and the assembly means is as shown in FIGS. 8A to 8E.

As shown in FIGS. 8A and 8B, firstly the plurality of branch lines 21 of the transmission cable 20 are inserted into the plurality of insertion slots 1511a of the first body 151a.

Then, as shown in FIGS. 8C and 8D, the second body 152a is assembled on the first body 151a, such that the hooks 1512a of the first body 151a are engaged in the holes 1524a of the second body 152a. At this time, one end of each of the plurality of piercing terminals 153a pierces the insulation sheath of the plurality of branch line 21 and contacts the conductive core of the plurality of branch line 21, thus achieving an electrical connection between the plurality of piercing terminals 153a and the plurality of branch lines 21.

After that, as shown in FIG. 8E, the outer lid 16a is opened relative to the casing 11a, thereby exposing the accommodating space 112a of the casing 11a. Furthermore, the guiding protruding parts 1523a of the adapter module 15a are aligned to the plurality of guide channels 121a, enabling the adapter module 15a to guide the plurality of guiding protruding parts 1523a to slide by means of the guide channels 121a. In this way, the adapter module 15a is accurately placed at the desired location in the accommodating space 112a, so that the plurality of elastic arm structures at another end of the plurality of piercing terminals 153a of the adapter module 15a may electrically contact the plurality of conductive contacts 131a in the accommodating space 112a accurately. Finally, the outer lid 16a is closed, thus completing the assembly of the transmission cable 20 and the connector 10a.

Based on the two embodiments mentioned above, the connector 10 of the adapter module 15 and the connector 10a of the adapter module 15 are modularized, and the adapter modules 15 and 15a are adapted for both the connector 10 with a male-type joint and the connector 10a with a female-type joint. For example, when a transmission cable 20 is required to be changed from the connector 10 (male-type joint) to the connector 10a (female-type joint), it is unnecessary to detach the plurality of branch lines 21 of the transmission cable 20 from the plurality of piercing terminals 153, instead, the transmission cable 20 is detached along with the adapter module 15. In this way, a detaching step between the transmission cable 20 and the plurality of piercing terminals 153 is avoided, thereby ensuring the connection quality between the transmission cable 20 and the plurality of connectors 10 and 10a.

According to the connector of one of the above embodiments, the adapter module is modularized and detachably assembled in the accommodating space of the casing, so that the transmission cable, together with the adapter module, is adapted for different types of connectors, thereby avoiding the detaching action of the transmission cable from the plurality of piercing terminals. As a result, the connection quality between the transmission cable and the connector is improved, and the service life and reliability of the connector are enhanced.

In addition, with the configuration of a plurality of elastic arm structures on the plurality of piercing terminals, the electrical contact effect between the plurality of piercing terminals and the circuit board is improved.

What is claimed is:

1. A connector, comprising:
a casing having an accommodating space;
a circuit board located in the accommodating space, and having a plurality of conductive contacts;
a joint assembled on the casing, and electrically connected to the circuit board; and
an adapter module detachably assembled in the accommodating space, and comprising:
a first body having a plurality of insertion slots;
a second body combined with the first body; and
a plurality of piercing terminals located on the second body, corresponding to the insertion slots, and electrically connected to the plurality of conductive contacts.

2. The connector according to claim 1, further comprising an outer lid assembled on the casing, and covering the adapter module.

3. The connector according to claim 2, wherein the outer lid is pivoted to the casing.

4. The connector according to claim 2, further comprising an engaging piece, assembled on one side of the casing and the side being away from the outer lid.

5. The connector according to claim 1, wherein each of the piercing terminals has a piercing end and a connection end opposite to each other, the second body has an inner surface and an outer surface opposite to each other, and the connection end protrudes outward from the outer surface and is electrically connected to one of the plurality of conductive contacts.

6. The connector according to claim 5, wherein the piercing end of each of the plurality of piercing ends has two piercing components arranged side by side.

7. The connector according to claim 5, wherein the piercing end of each of the plurality of piercing ends has three piercing components arranged in a staggered form.

8. The connector according to claim 5, wherein the connection end of each of the plurality of piercing ends has an elastic arm structure.

9. The connector according to claim 1, wherein the joint has a plurality of electrical contacts electrically connected to the plurality of conductive contacts of the circuit board.

10. The connector according to claim 9, wherein the plurality of electrical contacts are exposed outside the casing.

11. The connector according to claim 9, wherein the casing has a slot where the joint is located and the electrical contacts are exposed.

12. The connector according to claim 11, further comprising a grounding piece located in the slot.

13. The connector according to claim 1, further comprising a carrier located in the accommodating space, and the circuit board is located on the carrier.

14. The connector according to claim 13, wherein the carrier further has at least one guide channel, and the second body of the adapter module further has at least a guiding protruding part located in the guide channel.

15. The connector according to claim 13, further comprising a rear cover fixed on one end of the carrier, and positioned on one end of the circuit board, and the side is away from the joint.

16. The connector according to claim 1, wherein the casing further has at least a guide channel, and the adapter module further has at least a guiding protruding part located in the guide channel.

17. The connector according to claim 1, wherein the first body further has a hook, the second body further has a hole, and the hook is engaged with the hole.

18. The connector according to claim 1, wherein the adapter module further comprises a spacer sheet combined with the first body.

19. The connector according to claim 1, further comprising a retainer ring assembled on the casing.
